(19) United States
(12) Patent Application Publication
(10) Pub. No.: US 2021/0308963 A1
(43) Pub. Date: Oct. 7, 2021

(54) METHOD FOR MANUFACTURING A BAGGED PREFORM OF A COMPONENT MADE OF COMPOSITE MATERIAL AND METHOD FOR MANUFACTURING SAID COMPONENT

(71) Applicant: Airbus Operations SAS, TOULOUSE (FR)

(72) Inventors: Bertrand DUTHILLE, TOULOUSE (FR); Maxime PERCEVAULT, TOULOUSE (FR)

(21) Appl. No.: 17/222,137

(22) Filed: Apr. 5, 2021

(30) Foreign Application Priority Data
Apr. 7, 2020 (FR) 2003464

(51) Int. Cl. B29C 70/44; B29C 70/54; B29C 51/02

(52) U.S. Cl. CPC B29C 70/44; B29C 51/02; B29C 70/54

(57) ABSTRACT

A simple, inexpensive and rapid method for manufacturing a preform of a component made of composite material provided with a vacuum bagging film in which a thermoplastic vacuum bagging film is formed at the same time as the preform and a method for manufacturing a component made of composite material, by vacuum curing of the preform.

### CROSS-REFERENCES TO RELATED APPLICATIONS

This application claims the benefit of the French patent application No. 2003464 filed on Apr. 7, 2020, the entire disclosures of which are incorporated herein by way of reference.

### FIELD OF THE INVENTION

The present invention deals with a method for manufacturing a bagged preform of a component made of composite material.

A bagged preform is a preform provided with a vacuum bagging film

The invention relates also to a method for manufacturing this component made of a composite material by vacuum curing of the preform.

This component can notably be a stiffener of a self-stiffened panel made of composite material used, in particular, in the field of aircraft construction.

### BACKGROUND OF THE INVENTION

Components made of composite materials formed from reinforcing fibers embedded in a hardened resin are widely used, in particular in the aeronautical industry.

Indeed, efforts are increasingly being made to use such components in the field of aircraft construction, particularly as structural elements.

These components are, for example, parts comprising a face provided with ribs or relief structures, such as self-stiffened aircraft panels.

Self-stiffened panels with U-shaped integrated stiffeners, which is a configuration that makes it possible to obtain optimal mechanical properties for aircraft structural parts, and a method for placing elements of such panels for them to be cured are described in the document EP-A1-1 537 982.

To manufacture these components made of composite materials, the first step is to prepare a preform, and then the latter is cured and polymerized under pressure in an autoclave.

Before performing the curing of the preform, it is necessary to place the preform in a vacuum during a so-called vacuum bagging or packaging operation.

This operation is essential to allow the pressure of the autoclave to be distributed during the curing, and polymerization, which makes it possible, for its part, to obtain a final part that has the desired geometry and properties.

Vacuum bagging therefore consists in arranging and sealing a film on a preform before the latter is cured. The preform can be positioned on a molding tool. The preform can, for example, be in the form of a fabric of reinforcing fibers pre-impregnated with a hardenable resin, possibly laminated, or be a dry fibrous preform intended to be subsequently embedded in a hardenable resin, for example by a resin infusion technique.

As it turns out, the vacuum bagging techniques require the use of costly and complex tools.

Furthermore, the vacuum bagging techniques have been shown to be difficult to use in the context of the manufacturing of bulky or long components, such as the components that are intended to form the wings of aircraft, which can comprise structural sections that are longer than 10 meters.

Furthermore, in the context of parts or components, comprising a face provided with ribs or relief structures, such as self-stiffened aircraft panels, like those described in the document EP-A1-1 537 982 already cited, elastomer profiles are generally used as bagging films in order to distribute the pressure prevailing in the autoclave over all the surface of the stiffeners, in order to obtain a maximum compacting of the laminate without porosity, and the geometry and the thicknesses sought.

Elastomer profiles have the advantage of being able to be reused several times, that is to say, they can be used for several curings and polymerizations, but their life remains limited because of their brittleness in handling and their accelerated ageing in the temperature and pressure conditions which prevail in an autoclave, for example 7 bar at 180° C.

The cost of these profiles is also very high because of the basic price of the material, generally a silicon elastomer, but also the cost of transformation of the elastomer into a profile, generally performed under a press or in an autoclave.

Furthermore, in the case of parts or components comprising a face provided with ribs or relief structures, such as self-stiffened aircraft panels, the vacuum bagging film, generally made of elastomer, must generally be positioned on the face provided with the ribs, which complicates the process of obtaining a fitted covering of the face by the film

To remedy these problems, the document EP-A1-3115184 has proposed a vacuum bagging system comprising a vacuum bagging film thermoformed into an outer form of the component to be manufactured, the latter being, for example, a self-stiffened panel.

One method proposed in this document for thermoforming the vacuum bagging film relies on the use of vacuum-creating and heating modules each configured to cover a stiffening rib (see, in particular, FIGS. 3 and 4 of the document EP-A1-3115184 mentioned above), which represents an implementation cost which remains relatively high.

Other methods proposed in this document for thermoforming the vacuum bagging film rely on the use, facing the vacuum bagging film, of an air blowing device configured to apply an aerodynamic pressure to the film, during the thermoforming thereof (see, in particular, FIGS. 1 and 2 of the document EP-A1-3115184 mentioned above). When the aim is to obtain a film of large dimensions, such a device does however prove costly to produce and impractical to use.

When manufacturing components made of composite material, in addition to the vacuum bagging films, such as profiles made of silicone elastomer, other products are also used, such as drainage products, and mastics.

All these products present several drawbacks. Notably, they have a high cost, they are disposable, it takes a long time to implement them and that increases the overall component manufacturing time.

The aim of the invention is notably to provide a solution to the problems set out above in the preform vacuum bagging methods, and the methods for manufacturing components made of composite material by vacuum curing of these preforms.

The aim of the invention is, in particular, to simplify the vacuum bagging method, notably by limiting the quantities of materials used and their cost, and by reducing the quantity of waste and the duration of the method.

### SUMMARY OF THE INVENTION

This aim, and others, are achieved, in accordance with the invention, by a method for manufacturing a preform of a component made of composite material provided with a vacuum bagging film, this method comprising the following successive steps:
a) deposition of a thermoplastic vacuum bagging film on a forming tool, the form of which conforms to an outer form or geometry of the preform;
b) deposition of a sheet of a material constituting the preform on the forming tool;
c) deposition of at least one anti-adhesive layer, preferably of at least two anti-adhesive layers, on the sheet of a material constituting the preform;
d) thermoforming of the thermoplastic film, of the sheet of a material constituting the preform, and of the anti-adhesive layer or layers, on the forming tool;
e) separation of the preform provided with the thermoplastic vacuum bagging film, which is located on the forming tool, from the anti-adhesive layer or layers;
f) removal of the forming tool so as to obtain the preform provided with the thermoplastic vacuum bagging film.

The method according to the invention provides a simple, inexpensive and rapid method for manufacturing a preform of a component made of composite material provided with a vacuum bagging film.

In the method according to the invention, the thermoplastic vacuum bagging film is formed, or more precisely thermoformed, in the step d), at the same time as the preform, which constitutes a considerable simplification compared to the methods in which the preform and the vacuum bagging film are formed separately, and in which the previously formed vacuum bagging film is then arranged on the preform which has also been previously formed.

The method according to the invention allows the thermoplastic film to fit perfectly to the geometry of the preform and thus ensure the quality of the radii and ribs in the curing and polymerization step in the autoclave.

Notably, the thermoplastic film ensures that a uniform pressure is applied to the stiffeners during the polymerization.

The method according to the invention provides a solution to the problems explained above.

The method according to the invention allows for significant savings, notably in terms of material costs, because the thermoplastic vacuum bagging films implemented according to the invention are much less costly than the profiles made of elastomers, even if the latter can possibly be reused.

The sourcing of the thermoplastic vacuum bagging film can be done easily, notably in the form of a roll, which is much simpler than forming a profile made of elastomer to the geometry of the part and then positioning it.

Furthermore, in the method according to the invention, the thermoplastic film is formed simultaneously with the forming, or more specifically with the thermoforming, of the preform, which limits the steps and considerably reduces the duration of the method.

The method according to the invention comprises a smaller number of operations, and its duration is therefore shorter, it uses a much smaller quantity of materials and it produces less waste.

According to other advantageous aspects of the invention, the method according to the invention for manufacturing a preform of a component made of composite material provided with a vacuum bagging film has one or more of the following features, taken in isolation or in all technically possible combinations:
the thermoforming of the step d) is a vacuum thermoforming with an elastomer membrane placed in a vacuum and with heating, by infrared radiation, of the forming tool, of the thermoplastic film, of the sheet of a material constituting the preform, of the anti-adhesive layer or layers, and of the elastomer membrane; the elastomer membrane then being removed;
the thermoforming of the step d) is a mechanical thermoforming (without vacuum) with a press and a heated die;
the thermoforming of the step d) is a thermoforming in an autoclave or in an oven;
the component is a stiffener of a self-stiffened panel;
the material constituting the preform comprises reinforcing fibers pre-impregnated with a hardenable resin.

According to a preferred embodiment of the method of the invention, the component is a self-stiffened panel made of composite material comprising a base skin on one of the faces of which rib-forming L-shaped stiffeners are added and arranged side-by-side, of which the base parts of the L are pressed against the skin, with insertion, between the facing branches of the L of two adjacent stiffeners, of an interfacing structure called “nail,” comprising two attached half-nails.

According to another preferred embodiment of the method of the invention, the component is a self-stiffened panel made of composite material comprising a base skin on one of the faces of which rib-forming U-shaped stiffeners are added and arranged side-by-side, of which the link parts between the branches of the U are pressed against the skin, with insertion, between the facing branches of the U of two adjacent stiffeners, of an interfacing structure called “nail,” comprising two attached half-nails.

The method for manufacturing the preform of such a component comprises the following successive steps:
A) manufacturing of preforms of U-shaped stiffeners, each provided with a thermoplastic vacuum bagging film on the internal surfaces of the U, and each being located on a forming tool with inverted U-shaped conformal section, by the steps a) to e) of the method described above;
B) turning over of each of the forming tools by 180°;
C) placement, on each of the flanks of each coated forming tool, of a half-nail;
D) individual compacting of each forming tool provided with the half-nails;
E) positioning of the forming tools side-by-side on the base skin so as to apply against this skin a continuous flat surface defined, on the one hand, by the outer face of the link parts between the branches of the Us of the preforms of the stiffeners and, on the other hand, by the nails separating two adjacent stiffener preforms;
F) removal of the forming tools;
G) assembly of all the thermoplastic vacuum bagging films of the stiffener preforms to obtain a single thermoplastic vacuum bagging film.

Because the step A) is performed by means of the method for manufacturing, according to the invention, a component made of composite material provided with a thermoplastic vacuum bagging film, this method has all the advantages inherent in this method which have already been explained above.

In particular, the vacuum-creating packaging is already in place upon the integration of the stiffeners on the panel which results in a reduction in the consumables compared to the known methods.

This manufacturing method could easily be adapted by the person skilled in the art to manufacture a self-stiffened panel made of composite material comprising a base skin on one of the faces of which rib-forming L-shaped stiffeners are added and arranged side-by-side, of which the base parts of the L are pressed against the skin, with insertion, between the facing branches of the L of two adjacent stiffeners, of an interfacing structure called “nail,” comprising attached half-nails.

The invention relates also to a method for manufacturing a component made of composite material, by vacuum curing, comprising the following successive steps:
A1) manufacturing of a preform of the component made of composite material provided with a thermoplastic vacuum bagging film by means of the method described above;
B1) vacuum curing of the preform;
C1) obtaining of the component made of composite material.

Because the step A1) is performed by means of the method for manufacturing, according to the invention, a component made of composite material provided with a thermoplastic film, this method has all the advantages inherent in this method which have already been explained above.

The invention will be better understood, and other details, advantages and features thereof will become apparent on reading the following description given as a nonlimiting example and with reference to the attached drawings.

### BRIEF DESCRIPTION OF THE DRAWINGS

FIGS. 1 and 2 are schematic side views which respectively illustrate successive steps a) to d) of a method for manufacturing a preform of a component made of composite material, such as a self-stiffened panel stiffener, provided with a thermoplastic vacuum bagging film, according to a preferred embodiment of the invention.

FIGS. 3, 4 and 5 are schematic side views which respectively illustrate steps B) to G) of a method for manufacturing a preform of a component made of composite material according to a preferred embodiment of the method of the invention in which the component is a self-stiffened panel made of composite material.

Throughout these figures, identical references can denote identical or similar elements.

### DETAILED DESCRIPTION OF THE PREFERRED EMBODIMENTS

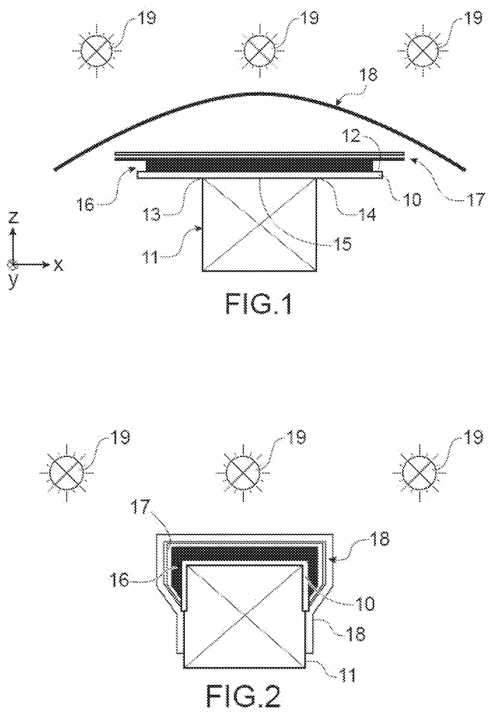

FIGS. 1 and 2 schematically illustrate successive steps a) to d) of a method for manufacturing a preform of a component made of composite material provided with a thermoplastic vacuum bagging film, according to a preferred embodiment of the invention, in which the thermoforming (step d)) is a vacuum thermoforming, with an elastomer membrane placed in a vacuum and with heating by infrared radiation of the forming tool, of the thermoplastic film, of the anti-adhesive layers, and of the membrane that have been deposited.

Such a preform provided with such a vacuum bagging film is intended for the manufacturing of a component made of composite material by vacuum curing, as will emerge more clearly hereinbelow.

The method according to the invention is, here, more particularly intended for the production of a preform of a stiffener of a self-stiffened panel.

The first step a) of the method according to the invention comprises the deposition of a thermoplastic vacuum bagging film 10 on a forming tool 11, the form of which conforms to an outer form or geometry of the preform that is wanted to be prepared.

In the present description, for convenience, an orthonormal reference frame XYZ is defined, in which the direction Z is locally orthogonal to the forming tool 11 and corresponds to the heightwise direction when the forming tool 11 is arranged horizontally (such an orientation not however being necessary to the implementation of the method in its most general definition).

A thermoplastic film 10 is understood to be a film that comprises one or more thermoplastic polymers.

Different types of thermoplastic films can be used. The film is selected notably so as to obtain a uniform distribution of the pressure on the surface of the preform during the curing and vacuum polymerization thereof in an autoclave.

The thermoplastic film can notably comprise one or more thermoplastic polymers, preferably selected from among the polyamides such as Nylon®, and the polyesters such as poly(ethylene terephthalate)s (PET).

A thermoplastic film made of polyamide has good elongation characteristics with a greater thickness than a film made of polyester, such as a PET, which remains more rigid, and for which a lesser thickness is sufficient.

Generally, the thermoplastic film exhibits an elongation at break of 250 to 400% and has a thickness of 100 μm to 400 μm, preferably of 300 to 400 μm, for example of 350 μm.

The thickness of the films made of polyamides is generally from 300 μm to 400 μm, and the thickness of the films made of polyesters is generally from 100 μm to 150 μm.

The elongation at break is greater for the films made of polyamides than for the films made of polyesters.

The thermoplastic vacuum bagging film can comprise one or more thermoplastic polymers, preferably selected from among the polyamides such as Nylon®, and the polyesters such as poly(ethylene terephthalate)s (PET), this or these polymers being co-extruded with a fluoropolymer such as an ethylene tetrafluoroethylene (ETFE), a polytetrafluoroethylene (PTFE) or a perfluoro ethylene propylene (PFEP), also called fluorinated ethylene propylene (FEP) resin. The PFEP (FEP resin) is a copolymer of hexafluoropropylene and tetrafluoroethylene.

The film 10 thus has anti-adhesive properties, at least on one face 12 (top face according to Z), allowing the component to be stripped from the mold at the end of the vacuum curing thereof, and without the component being polluted.

In other embodiments, the film 10 comprises one or more thermoplastic polymers, preferably chosen from among the polyamides such as Nylon®, and the polyesters, having undergone, for example, a physico-chemical treatment, such as a plasma or corona treatment, making it possible to confer on the film 10 the abovementioned anti-adhesive properties. More specifically, the surface tension of the surface 12 of the film 10 in contact with the preform can be modified by a physico-chemical treatment, such as a plasma or corona treatment.

The film 10 can possibly be multilayered and can comprise, in the different layers, materials having different properties, such as vacuum-tightness properties, adhesive properties, or, on the other hand, anti-adhesive properties (self-releasing).

For example, a self-releasing film made of fluoropolymer (see above) can be incorporated in the film 10 to allow easy stripping of the composite part from the mold after curing and polymerization, and without pollution.

The forming tool 11, such as a forming punch, has a form which conforms to an outer form or geometry of the preform that is wanted to be prepared.

As an example, in the figures, the forming tool 11 has a section in parallelogram form (in planes XZ), for example of rectangular form. The top corners (in the direction Z) 13, 14, of this parallelogram, can be rounded. This form conforms to the U-shaped form of a self-stiffened panel stiffener preform.

The forming tool 11 has a flat bearing top surface 15, on which the thermoplastic film 10 is deposited.

A shoulder (not represented) can be provided in the forming tool 11 to offset the overthickness induced by the thermoplastic film 10.

Likewise, cavities (not represented) can be provided in the forming tool 11 to incorporate reinforcements generally made of a material similar to the material constituting the preform, such as a pre-impregnated material.

The deposition of the film 10 is, for example, done by extending the film 10 from a roll, or by directly extruding the film on the flat bearing top surface 15 of the forming tool 11.

At the end of the deposition, the film 10, which is flat, rests on the flat bearing top surface 15 of the forming tool 11.

A second step b) of the method according to the invention comprises the deposition of a sheet 16 of a material constituting the preform on the thermoplastic sheet 10.

The material constituting the preform can be a fabric of reinforcing fibers pre-impregnated with a hardenable resin, possibly laminated, or be a dry fibrous preform intended to be subsequently embedded in a hardenable resin, for example by a resin infusion technique.

The sheet 16, before forming, is flat.

A third step c) of the method according to the invention comprises the deposition of at least one layer, preferably of at least two layers, generally two layers, anti-adhesive and self-releasing, on the sheet of a material constituting the preform previously deposited. For example, as is represented in FIG. 1, this step can comprise the deposition of two anti-adhesive layers 17.

The anti-adhesive layer or layers 17 are generally made of a fluoropolymer as described above. A fourth step d) of the method according to the invention comprises the thermoforming of the thermoplastic film 10, of the sheet of a material constituting the preform 16, and of the anti-adhesive layer or layers 17, on the forming tool 11.

According to a preferred embodiment of the invention, as shown in FIGS. 1 and 2, the thermoforming (step d)) is a vacuum thermoforming with an elastomer membrane 18 placed in a vacuum, and with heating, by infrared radiation, of the forming tool 11, of the thermoplastic film 10, of the sheet of a material constituting the preform 16, of the anti-adhesive layer or layers 17, and of the elastomer membrane 18.

More specifically, as FIG. 1 shows, an elastomer membrane 18 is placed on a frame (not represented) on top of the forming tool 11, the thermoplastic film 10, the sheet of a material constituting the preform 16, and the anti-adhesive layer or layers 17. In other words, the elastomer membrane 18 is incorporated in the forming machine directly on its top part.

This elastomer membrane 18 is a simple sheet and not a profile shaped by complex operations as in the methods of the prior art.

This elastomer membrane 18 is generally made of a silicone (polysiloxane), but other elastomers are also available on the market for the forming

This elastomer membrane 18, under the effect of the vacuum, will mechanically form the preform and the thermoplastic film 10 on the forming tool 11. This membrane can therefore be called forming membrane.

The step d) then comprises the heating, by infrared radiation, of the forming tool 11, of the thermoplastic film 10, of the sheet of a material constituting the preform 16, of the anti-adhesive layer or layers 17, and of the membrane 18, and the thermoforming of the thermoplastic film 10, of the sheet 16, of the anti-adhesive layer or layers 17, and of the elastomer membrane 18, on the forming tool 11.

In FIGS. 1 and 2, the heating by infrared radiation is provided by infrared lamps 19.

As an example, three infrared lamps 19 are represented in FIGS. 1 and 2, arranged above the elastomer membrane 18, or more specifically above the frame supporting this membrane, but a different number of infrared lamps arranged differently could be implemented.

The heating needs to be such that it allows the thermoforming temperature of the material constituting the preform to be reached.

Generally, and whatever the embodiment of the thermoforming step d), the thermoforming temperature of the material constituting the preform, which can be situated, for example, around 90° C., also corresponds to the state-change temperature (Tg for example) of the thermoplastic polymers mainly used to constitute the thermoplastic film 10, such as the polyamides and polyesters.

It is thus possible to obtain a slight plastic deformation which thus sets the preform in its form.

This thermoforming temperature, generally around 90° C., is sufficient to ensure that the geometry of the thermoplastic film thus formed is maintained.

When the thermoforming temperature of the material constituting the preform 16 is reached, the frame descends, the elastomer membrane 18 then envelopes the forming tool 11, the thermoplastic film 10, the sheet of a material constituting the preform 16, and the anti-adhesive layer or layers 17.

The step then comprises the placing of the duly positioned elastomer membrane 18 in a vacuum. It is the deformation of the elastomer membrane 18 under the action of the vacuum which deforms the material constituting the preform 16.

The elastomer membrane 18 is kept in a vacuum for sufficient time for the preform to be deformed and for the thermoforming to be carried out.

FIG. 2 shows the forming tool 11 on which there has been formed, in the step d), the thermoplastic film 10, the sheet 16, and the anti-adhesive layer or layers 17, with the membrane 18.

In FIG. 2, the sheet 16, initially flat, has been formed into a preform which has the geometry of the component that is wanted to be prepared. Thus, in FIG. 2, the sheet 16 has formed, on the forming tool, a U-shaped preform which is the form of a self-stiffened panel stiffener that is wanted to be prepared.

The person skilled in the art will understand that L-shaped preforms could also be prepared, through a few adaptations of the method.

At the end of the abovementioned period for which the vacuum is maintained, the step comprises the cooling of the elastomer membrane 18 to ambient temperature.

The cooling is generally a forced air cooling, for example performed under pulsed air.

At the end of the cooling, the elastomer membrane 18 is raised and removed, more specifically, the top part of the forming machine with the elastomer membrane 18 is opened.

According to another embodiment, the thermoforming of the step d) can be a mechanical thermoforming (with no vacuum applied) performed with a press and a heated die.

In other words, instead of a membrane, a mechanical die is used, and no vacuum is applied.

The die is heated to the thermoforming temperature by heating by infrared or other radiation, or by conduction, then the duly heated die is brought to the sheet of material constituting the preform 16.

The die can be a die called self-heating die with incorporated heating means.

According to yet another embodiment, the thermoforming of the step d) can be a thermoforming in an autoclave or in an oven.

This thermoforming in an autoclave or in an oven is also performed using an elastomer membrane. The autoclave or the oven is used for their heat input in the same way as the infrared lamps, and the vacuum system of the autoclave or of the oven is used.

A fifth step e) of the method according to the invention comprises the separation of the preform 16 provided with the thermoplastic vacuum bagging film 10 (on the one hand), and the anti-adhesive layer or layers 17 (on the other hand) The preform 16, provided with the thermoplastic vacuum bagging film 10, is, in this step, still located on the forming tool 11.

A sixth step f) of the method according to the invention comprises the removal of the forming tool 11, whereby the preform 16 provided with the thermoplastic vacuum bagging film 10 is obtained.

According to a particularly preferred embodiment, the component is a self-stiffened panel made of composite material comprising a base skin on one of the faces of which rib-forming U-shaped stiffeners are added and arranged side-by-side, of which the link parts between the branches of the U are pressed against the skin, with insertion, between the facing branches of the U of two adjacent stiffeners, of an interfacing structure commonly called “nail,” comprising attached half-nails.

This method comprises the steps A) to G) explained above.

The step A) comprises the manufacturing of preforms of U-shaped stiffeners, each provided with a thermoplastic vacuum bagging film 10 on the internal surfaces of the U, and each being located on a forming tool 11 with inverted U-shaped conformal section, by the steps a) to e) of the method described above.

FIG. 2 shows the forming tool 11 on which has been formed, in the step d) of the method described above, the thermoplastic film 10, the sheet 16, and the anti-adhesive layers 17.

FIG. 2 also shows an elastomer membrane 18, which is used when the thermoforming (step d)) is a vacuum thermoforming with an elastomer membrane 18 placed in a vacuum. This elastomer membrane 18 is then removed.

In FIG. 2, the sheet 16 has formed a U-shaped preform (also designated 16) which is the form of a self-stiffened panel stiffener that is wanted to be prepared.

The fifth step e) of the method described above comprises the separation of the preform 16 provided with the thermoplastic vacuum bagging film 10 (on the one hand) and the anti-adhesive layer or layers 17 (on the other hand), whereby preforms of U-shaped stiffeners are thus obtained, each provided with a thermoplastic vacuum bagging film 10 on the internal and bottom surfaces of the U, and each being located on a forming tool 11 with inverted U-shaped conformal section.

The step B) comprises the turning over of each of the forming tools by 180°.

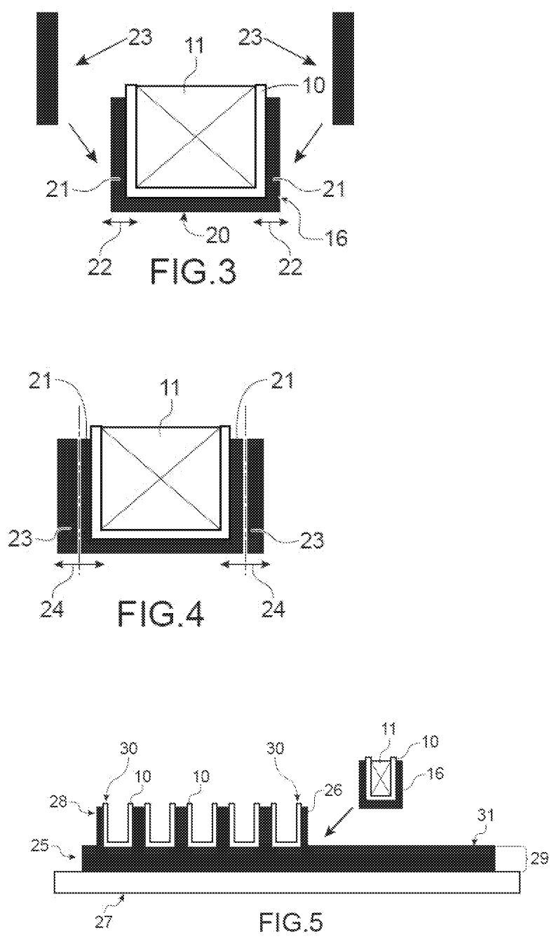

Each of the forming tools 11 is then in the configuration shown in FIG. 3, the U of the preform 16 being in normal non-inverted position with the link part of the U forming the base 20 of the preform, in bottom position. This link part of the U forming the base of the preform is situated between two branches of the U forming the flanks 21 of the preform which extend vertically upward from the base 20.

In other words, the preform 16 forms a U-shaped profile on the forming tool 11 that is oriented downwards. The branches of the U or flanks 21 then form the radii or ribs of the preform of the ribbed panel.

To prevent the preforms of U-shaped stiffeners, each provided with a thermoplastic vacuum bagging film 10, from dropping, adhesive securing tapes can be put in place at the junction between the thermoplastic film 10 and the forming tool 11 (care will be taken to ensure that there is no contact between the “cool” preform and the adhesive tape). An “excess length” is left on the thermoplastic film 10.

The adhesive tapes are removed in the step E) which comprises the positioning of the forming tools 11, and before the step F) which comprises the removal of the forming tools 11.

In other words, the adhesive tapes are removed once the panel has been formed, just before removing the forming tools 11 from the panel.

A system of magnetized bar type can be envisaged to avoid using an adhesive tape.

The flanks 21 of the preform can have a thickness 22 of 3 to 10 mm.

The step C) comprises, as FIG. 3 shows, the placement on each of the flanks 21 of the preform of a half-nail 23.

The two half-nails 23 can have a thickness of 3 to 6 mm.

The two half-nails 23 are generally made of the same material as the preform 16.

This step can comprise, in addition, the placement between each of the two branches of the U forming the flanks 21 of the preform 16, and each of the two half-nails 23, of a filling resin (not represented) to fill the space which may exist between the flanks 21 and the half-nails 23.

The filling resin generally comprises the same material as the preform, for example a fabric of reinforcing fibers pre-impregnated with a hardenable resin, possibly laminated.

The step D), shown in FIG. 4, comprises the individual compacting of each forming tool 11 provided with the half-nails 23 on the flanks 21 of the preform, and possibly a filling resin.

The compacting is a mechanical compacting which is performed using dedicated means. Thus, the compacting can be performed, for example, by placing two inflatable cushions on each side of the preform of the stiffener. These inflatable cushions come into contact with the preform of the stiffener.

This compacting operation is performed to make the elements adhere to one another and not to reduce porosity.

At the end of this step, each preform, shown in FIG. 4, after compacting, forms a U-shaped profile provided with half-nails 23, on the flanks 21 of the preform, and its flanks have a thickness which has been increased by the thickness of each of the half-nails 23. This thickness 24 can, for example, be from 3 to 6 mm.

The step E), shown in FIG. 5, comprises the positioning of the forming tools 11 side-by-side on the base skin 25, so as to apply, against this skin 25, a continuous flat surface, defined, on the one hand, by the outer face of the link parts or bases 20 between the branches of the Us of the preforms of the stiffeners, and, on the other hand, by the nails 26 separating two adjacent stiffener preforms. A preform of the ribbed panel is thus obtained.

The base skin 25 of the preform 28 of the ribbed panel is generally arranged on a molding tool 27.

The preform 28 comprises, for example, a panel portion 29 formed by the skin 25, the bases of the preforms of the stiffeners and the bases of the nails, on the side 31 of the preform arranged on the molding tool 27. The flanks of the preforms of the stiffeners and the nails 26 form the ribs 30 of the preform.

The molding tool 27 is configured to support the preform 28.

The step F), also shown in FIG. 5, comprises the removal of the forming tools 11, one after the other.

The thermoplastic vacuum bagging film 10 remains in place, and closely fits the geometry of the stiffeners.

The step G) comprises the assembly of all the bagging films of the stiffener preforms to form a single thermoplastic vacuum bagging film

The vacuum bagging films 10 of each stiffener preform are assembled at the respective tops of the ribs 30 to form a single vacuum bagging film Such an assembly makes it possible, in particular, to best avoid the contact between the joining zones of the films and the component, before curing thereof. That is advantageous inasmuch as the joins in some cases result in a local overthickness of the assembly of the films likely to mark the component.

Each join can be made by means of mastic inserted between two consecutive films 10 so that the mastic constitutes the top of the corresponding rib 30.

At this stage, conventional accessory tool elements can be put in place on the thermoplastic vacuum bagging film.

In other words, prior to polymerization, and following the removal of the forming tools, the continuity of the placement of the vacuum packaging is assured, using various auxiliary products such as mastic, and metal elements are put in place which make it possible to hold the panel geometrically during polymerization.

The invention relates also to a method for manufacturing a component made of composite material, by vacuum curing, comprising the following successive steps:
A1) manufacturing of a preform of the component made of composite material provided with a thermoplastic vacuum bagging film by means of the method described above;
B1) vacuum curing of the preform;
C1) obtaining of the component made of composite material.

The step B1) comprises the creation of a partial vacuum in the space formed between, on the one hand, the thermoplastic vacuum bagging film, or the assembly of vacuum bagging films, and, on the other hand, the preform and the molding tool, for the curing of the preform.

By that, it is important to understand that the step B1) comprises, if necessary, the infusion of resin in the case where the preform is a dry preform, and comprises, in all cases, the hardening of the resin within the space, placed in a partial vacuum, between the preform and the thermoplastic vacuum bagging film, culminating in the obtaining of the component made of composite material.

To this end, the step B1) preferably comprises heating, in a vacuum and under pressure, of the preform and of the resin. In this case, the result thereof is also heating of the vacuum bagging film or of the assembly of vacuum bagging films, which promotes a deformation of the vacuum bagging film or of the assembly of films causing the vacuum bagging film to most closely cover the preform and thus best avoids the presence of air pockets in the space between the preform and the thermoplastic vacuum bagging film Such a deformation of the film or of the assembly of films typically comprises a stretching thereof allowing for a fitted covering of the relief parts of the preform. In this case, such a stretching of the film notably allows for a fitted covering of radii connecting stiffeners to the panel portion.

In other words, in the step B1), the effect of the pressure prevailing in the autoclave, for example 7 bar, associated with the deformation of the thermoplastic film by heating, are among the key elements which make it possible to obtain a panel that has the desired quality.

As an example, the pressure which prevails in the autoclave is typically 6 to 11 bar for a monolithic part.

As an example, the temperature prevailing in the autoclave is typically 120° C. to 180° C., for example 120° C., 145° C. or 180° C., depending on the resin systems.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a preform of a component made of composite material provided with a vacuum bagging film, this method comprising the following successive steps:
a) depositing a thermoplastic vacuum bagging film on a forming tool, a form of the forming tool conforming to an outer form or geometry of the preform;
b) depositing a sheet of a material constituting the preform on the forming tool;
c) depositing at least one anti-adhesive layer on the sheet of a material constituting the preform;
d) thermoforming the thermoplastic film, the sheet of a material constituting the preform, and the anti-adhesive layer, on the forming tool;
e) separating the preform provided with the thermoplastic vacuum bagging film, which is located on the forming tool, from the anti-adhesive layer;
f) removing the forming tool to obtain the preform provided with the thermoplastic vacuum bagging film

2. The method according to claim 1, wherein the step of depositing at least one anti-adhesive layer comprises depositing two anti-adhesive layers on the sheet of material constituting the preform.

3. The method according to claim 1, wherein the thermoforming of step d) is a vacuum thermoforming with an elastomer membrane placed in a vacuum and with heating, by infrared radiation, of the forming tool, of the thermoplastic film, of the sheet of a material constituting the preform, of the anti-adhesive layer, and of the elastomer membrane; the elastomer membrane then being removed.

4. The method according to claim 1, wherein the thermoforming of step d) is a mechanical thermoforming with a press and a heated die.

5. The method according to claim 1, wherein the thermoforming of step d) is a thermoforming in an autoclave or in an oven.

6. The method according to claim 1, wherein the material constituting the preform comprises reinforcing fibers pre-impregnated with a hardenable resin.

7. The method according to claim 1, wherein the component is a stiffener of a self-stiffened panel.

8. The method according to claim 1, wherein the component is a self-stiffened panel made of composite material comprising a base skin, on one face of which, rib-forming L-shaped stiffeners are added and arranged side-by-side, of which base parts of the L-shaped stiffeners are pressed against said skin, with insertion, and between facing base parts of two adjacent L-shaped stiffeners, of an interfacing structure called “nail,” comprising two attached half-nails.

9. The method according to claim 1, wherein the component is a self-stiffened panel made of composite material comprising a base skin, on one faces of which, rib-forming U-shaped stiffeners are added and arranged side-by-side, of which link parts between branches of the U-shaped stiffeners are pressed against said skin, with insertion, and between facing branches two adjacent U-shaped stiffeners, of an interfacing structure called “nail,” comprising two attached half-nails.

10. The method according to claim 9, wherein the method comprises the following successive steps:
A) manufacturing preforms of stiffeners shaped as a U, each provided with a thermoplastic vacuum bagging film on internal surfaces of the U, and each being located on a forming tool with an inverted U-shaped conformal section, by the steps a) to e) of the method described above;
B) turning over of each of the forming tools by 180°;
C) placing, on each flank of each coated forming tool, of a half-nail;
D) individual compacting of each forming tool provided with the half-nails;
E) positioning the forming tools side-by-side on the base skin to apply against this skin a continuous flat surface defined by an outer face of the link parts between branches of the Us of the preforms of the stiffeners and by the nails separating two preforms;
F) removing the forming tools;
G) assembling all the thermoplastic vacuum bagging films of the stiffener preforms to obtain a single thermoplastic vacuum bagging film.

11. The method for manufacturing a component made of composite material, by vacuum curing, comprising the following successive steps:
A1) manufacturing a preform of the component made of composite material provided with a thermoplastic vacuum bagging film by means of the method according to claim 1;
B1) vacuum curing the preform;
C1) obtaining the component made of composite material.
